(19) United States
(12) Patent Application Publication
(10) Pub. No.: US 2010/0131293 A1
(43) Pub. Date: May 27, 2010

(54) INTERACTIVE MULTI-AXIS LONGITUDINAL HEALTH RECORD SYSTEMS AND METHODS OF USE

(75) Inventors: Steven Linthicum, Lake in the Hills, IL (US); Steven Fors, Chicago, IL (US); Anthony Ricamato, West Chicago, IL (US); Eric Jester, Hoffman Estates, IL (US)

Correspondence Address: HANLEY, FLIGHT & ZIMMERMAN, LLC, 150 S. WACKER DRIVE, SUITE 2100, CHICAGO, IL, 60606, US

(73) Assignee: General Electric Company, Schenectady, NY (US)

(21) Appl. No.: 12/324,543

(22) Filed: Nov. 26, 2008

(51) Int. Cl. G06Q 50/00; G06F 3/048

(52) U.S. Cl. 705/3; 715/835; 715/838

(57) ABSTRACT

Certain embodiments of the present invention provide graphical patient health record timeline systems and methods for providing electronic health record information within and across clinical patient encounters. Certain embodiments provide a graphical patient health record timeline interface system. The system includes a spectrum representation graphically representing different types of patient information. The representation is navigable by a user to access one or more clinical data elements relating to the patient. The system also includes a plurality of indicators dividing the representation based on encounter. Selecting a clinical data element in the representation provides additional information related to the clinical data element to the user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Current PACS and/or other reviewing systems provide all available medical information on a screen for a user. However, this information is not organized. In addition, there is currently no way to tell the user which of these data elements are important and which are not. Simply browsing through data is quite problematic as it is a huge disruption in a physician's workflow and often fails to yield the desired end user results.

A variety of clinical data and medical documentation is available throughout various clinical information systems, but it is currently difficult to find, organize, and effectively present the information to physicians and other healthcare providers at a point of care. There are a myriad of difficulties associated with this task. Current systems and methods perform static queries on single data sources, which generally returns information which may or may not be relevant and is typically incomplete.

Based on recent studies, computerized physician order entry errors have increased in approximately the last five years. According to the Journal of the American Medical Informatics Association in 2006, unintended adverse consequences from computer entry errors fell into nine major categories (in order of decreasing frequency): 1) more/new work for clinicians, 2) unfavorable workflow issues, 3) never-ending system demands, 4) problems related to paper persistence, 5) untoward changes in communication patterns and practices, 6) negative emotions, 7) generation of new kinds of errors, 8) unexpected changes in the power structure, and 9) and overdependence on technology. Poor usability and user interface design contributes to most if not all of these categories.

### BRIEF SUMMARY OF THE INVENTION

Certain embodiments of the present invention provide graphical patient health record timeline systems and methods for providing electronic health record information within and across clinical patient encounters.

Certain embodiments provide a graphical patient health record timeline interface system. The system includes a spectrum representation graphically representing different types of patient information. The representation is navigable by a user to access one or more clinical data elements relating to the patient. The system also includes a plurality of indicators dividing the representation based on encounter. Selecting a clinical data element in the representation provides additional information related to the clinical data element to the user.

Certain embodiments provide a method for presenting patient health record information in a timeline for user interaction. The method includes compiling patient health record information in a timeline for graphical representation in a spectrum format including clinical data elements for selection and review by a user via a user interface. The clinical data elements are separated by indicators on a separate axis indicating patient encounter boundaries. The representation is navigable by a user via the user interface to access one or more clinical data elements relating to the patient. The method also includes displaying additional information regarding a clinical data element in response to user interaction.

Certain embodiments provide a machine readable medium having a set of instructions for execution on a computing device. The set of instructions includes a spectrum patient health record representation graphically representing different types of patient information. The representation is navigable by a user to access one or more clinical data elements relating to the patient. The set of instructions also includes a plurality of indicators dividing the representation based on encounter. Selecting a clinical data element in the representation provides additional information related to the clinical data element to the user.

### BRIEF DESCRIPTION OF SEVERAL VIEWS OF THE DRAWINGS

FIG. 1 illustrates a workflow for providing adaptive, work-centered healthcare services in accordance with certain embodiments of the present invention.

FIG. 2 shows an example adaptive user interface in accordance with an embodiment of the present invention.

FIG. 3 depicts an example mobile device including a user interface, such as the user interface described in relation to FIG. 2.

FIG. 4 illustrates an example use case of an adaptive, work-centered user interface in perinatal care in accordance with an embodiment of the present invention.

FIG. 5 depicts a user interface architecture in accordance with certain embodiments of the present invention.

FIG. 6 depicts a visualization of an exemplary patient's complete medical record in accordance with certain embodiments of the present invention.

FIG. 7 shows an exemplary magnification of all or part of a patient record timeline to provide additional information regarding patient data points in accordance with certain embodiments of the present invention.

FIG. 8 depicts a further magnification of a particular event to view greater detail regarding the event and surrounding data in accordance with certain embodiments of the present invention.

FIG. 9 illustrates a further magnification of a patient record according to certain embodiments of the present invention.

FIG. 10 illustrates further magnification of a patient record timeline allowing a user to review and edit one or more data points in the record in accordance with certain embodiments of the present invention.

FIG. 11 depicts an example of a longitudinal health record including three-dimensional (“3D”) spectrum representation of patient information according to certain embodiments of the present invention.

FIG. 13 illustrates an alternative clinical information display provides names, colors, and links aiding a user in seeing connections between chronic diseases, medications, and treatment protocols in accordance with certain embodiments of the present invention.

FIG. 14 shows a network turbulence graph displaying relationships between discrete but disparate data types in accordance with certain embodiments of the present invention.

FIG. 15 shows a trending graph for interactive timeline visualization over the course of a patient's history, combining variables in accordance with certain embodiments of the present invention.

FIG. 16 shows a flow diagram for a method for interactive, multi-axis longitudinal health record display in accordance with certain embodiments of the present invention.

FIG. 17 shows a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide methods and systems for displaying and interacting with patient data within and between encounters. By utilizing a multi-dimensional display, the user has the ability to gain a greater understanding of comprehensive longitudinal data for a patient and to interact with discrete data elements across the continuum of a patient record.

Certain embodiments offer a clinician an easy view of anomalies in clinical data over time. Certain embodiments allow the user to view data from a macro view (e.g., across an entire patient record) to a micro view (e.g., an individual data element). Highlighting similar data elements across time accentuates the frequency of similar out-of-range data elements. This type of view provides improved insight into causal function(s) of underlying pathologies, for example.

Most current timelines are event-based; i.e., they are driven by encounters. Certain embodiments allow navigation by clinical element as opposed to the artificial restriction imposed by drilling down through patient encounters.

Certain embodiments provide a three-dimensional timeline view of clinical data. A clinical data elements axis contains individual data elements. The elements are labeled/indicated by color depending on data element type and relativity to normative values, for example. In one example, upon a mouse-over and/or other cursor positioning with respect to a particular data element, other data elements of the same type are highlighted across an entire patient record. By clicking on and/or otherwise selecting a data point on the timeline, the system can display an original data source complete with a full data context, for example.

Certain embodiments display clinical information such as medications, problems, allergies, immunizations, procedures, etc., that span individual patient encounters for review. This view allows the user to visually correlate chronic issues directly with data elements in the clinical data elements axis. On mouse over and/or other cursor positioning with respect to the issue, the user is presented with a summary view of that issue to date, for example. On mouse click and/or other selection, the user is presented with a list of clinical documents related to the issue and supplemental research material, for example.

Certain embodiments describe an innovative way to display and interact with individual data elements together as they relate to a patient's underlying health issues. Certain embodiments facilitate navigation of medical records via individual clinical elements. Certain embodiments also provide visual cross-referencing between problems and clinical elements for a patient. Certain embodiments provide a multi-axis display of electronic medical record (“EMR”) data.

Certain embodiments provide access by an end user to information across enterprise systems. Certain embodiments provide a search-driven, role-based, workflow-based, and/or disease-based interface that allows the end user to access, input, and search medical information seamlessly across a healthcare network. Certain embodiments offer adaptive user interface capabilities through a work-centered interface tailored to individual needs and responsive to changes in a work domain. Certain embodiments introduce an adaptive, work-centered user interface technology software architecture, which embodies two novel concepts. The first concept is to use an ontology modeling approach to characterize a work domain in terms of “work-centered” activities as well as computation mechanisms to achieve an implementation that supports those activities. The second concept is to provide adaptive interaction, both user directed and automated, in work-centered characterization and presentation mechanisms of the user interface to enterprise-level applications.

Healthcare information systems are most effective when users are able to find and make use of relevant information across a timeline of patient care. An adaptive user interface can leverage semantic technology to model domain concepts, user roles and tasks, and information relationships, for example. Semantic models enable applications to find, organize and present information to users more effectively based on contextual information about the user and task. Applications can be composed from libraries of information widgets to display multi-content and multi-media information. In addition, the framework enables users to tailor the layout of the widgets and interact with the underlying data.

In an example, a new level of adaptive user interface design is achieved by taking advantage of semantic Web technology. Domain concepts and relationships are characterized in a hierarchy of ontologies, associated with upper level ontological constructs that enable adaptive reasoning and extensibility.

Thus, certain embodiments offer adaptive user interface capabilities through use of a controller that can “reason” about metadata in an ontology to present users with a work-centered application tailored to individual needs and responsive to changes in a work domain. Targeted information can be delivered from “external” data in an application context-sensitive manner

In human-computer interaction, user interface data, events, and frequencies can be displayed, recorded, and organized into episodes. By computing data positioning on the screen, episode frequencies, and implication relations, certain example embodiments can automatically derive application-specific episode associations and therefore enable an application interface to adaptively provide just-in-time assistance to a user. By identifying issues related to designing an adaptive user interface, including interaction tracking, episodes identification, user pattern recognition, user intention prediction, and user profile update, an interface is generated that can act on a user's behalf to interact with an application based on certain recognized plans. To adapt to different users' needs, the interface can personalize its assistance by learning user profiles and disease-specific workflows, for example.

In certain embodiments, an adaptive user interface system includes a search engine, a Web server, an active listener, an information composition engine, a query engine, a data aggregator, a document summarizer, a profile context manager, and clinical and administrative dashboards, for example. Certain embodiments offer a complete view of an entire patient medical record in a user-specific, role-specific, disease-specific manner. In certain embodiments, a user interface can also be configured to provide operation views of data, financial views of data, and also serve as a dashboard for any type of data aggregation.

Certain embodiments provide an adaptive, work-centered user interface technology software architecture. The architecture uses an ontology modeling approach to characterize a work domain in terms of “work-centered” activities as well as computation mechanisms that achieve an implementation supporting those activities. The architecture also provides adaptive interaction, both user directed and automated, in the work-centered characterization and presentation mechanisms of the user interface to enterprise-level applications.

A work-centered solution helps provide an integrated and tailored system that offers support to work in a flexible and adaptable manner by customizing user interaction according to the situated context in which work is accomplished. Under a work-centered approach, an understanding of the overall targeted work domain is developed. For example, questions used to develop an understanding of the work domain can include what the work domain encompasses, what the goals of work are, who participates in the work domain, and how the participants achieve the goals of the work domain, given a local context. The understanding of the work domain can be used to characterize and, thus, support participants' day-to-day activities.

In certain embodiments, an active listener agent operates in a foreground and/or background of a computing device and/or software application, such as a user interface, to monitor user and program activity. For example, the active listener agent can gather information related to widgets in a user interface. The active listener agent can gather information related to actions generated by a user with respect to the user interface and its content, for example.

In certain embodiments, based on application (e.g., widget) information and user interaction, the active listener agent can identify information and/or functionality important to a user based on a current context. In an embodiment, if the active listener agent detects that one or more data elements displayed on a user interface reach a predetermined threshold, the active listener automatically places one or more widgets on the user interface that include additional relevant information to help enable the user to make a well-informed decision. In another embodiment, the active listener agent can help the user by reacting to the user's interaction with an application and provide additional insight by displaying additional information in the form of widget(s) and/or other information on a displayed user interface as a result of the user's actions. For example, if the user drags a certain data element from one widget to another widget (e.g., via cursor selection of the element and movement across a displayed interface using a mousing device), the active listener agent can reposition (e.g., size and/or location) that information on the displayed interface so that an arrangement of data elements signifies a different level of information useful in helping the user arrive at a conclusion (e.g., regarding diagnosis and/or treatment of a patient). The active listener agent can then either place a pre-made relevant widget on the interface that could be helpful a the particular scenario and/or can create a new widget based on the content of the widget the user changed in addition to the data context on the user interface.

Rather than focus on pre-determined workflows, the active listener provides a user with additional information helpful to the user in certain situations where there is no known workflow or protocol. Based on historical data and/or other input, the system displays additional information and/or functionality to the user that is relevant to the user to make an informed decision. In the background of an application and/or interface, for example, the active listener can monitor activity of data elements on a displayed interface. When these data elements reach a certain threshold, the active listener places additional information on the displayed interface to help the user make an informed decision. Alternatively or additionally, the active listener can detect when the user makes a change to an application (e.g., by dragging and dropping a data element from on widget to another widget, by conducting a search, by changing a diagnosis, etc.). By combining a context of user interaction with displayed user interface content, relevant information and/or functionality can be provided to a user, for example.

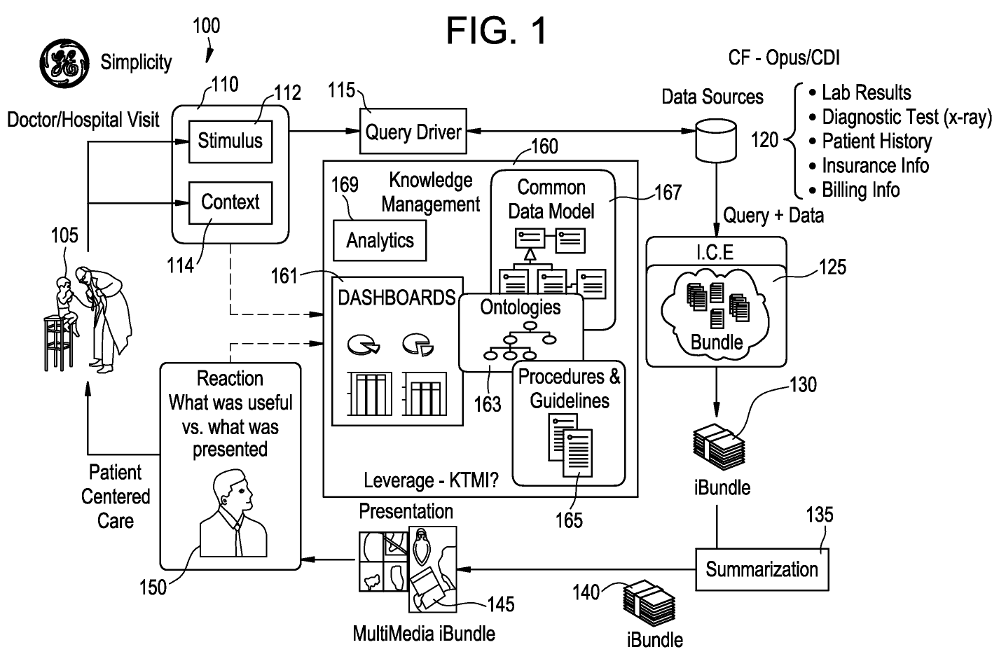

FIG. 1 illustrates a workflow 100 for providing adaptive, work-centered healthcare services in accordance with certain embodiments of the present invention. The workflow 100 includes a patient visit 105 to a doctor, hospital, clinic, etc. From the patient visit 105, a query 110 is generated by a clinician such as an examining physician, a nurse, etc. The query 110 can include a stimulus 112 observed and a patient context 114, for example. The query 110 is passed to a query driver 115. The query driver 115 can query one or more data source 120 and/or a knowledge management subsystem 160, for example. Data source(s) 120 can include one or more of lab results, diagnostic tests (e.g., x-ray, magnetic resonance image, ultrasound, etc.), patient history, insurance information, billing information, etc.

In certain embodiments, the query driver 115 can include and/or be in communication with a Query Enhancement Engine (“QUEEN”). Information may be represented in a plurality of formats including text (e.g., reports and papers), tables (e.g., databases), images (e.g., x-ray and computed tomography scans), and video (e.g., surgical procedures). Furthermore, information often reside on different systems and are stored and/or computed in a heterogeneous environment.

The Query Enhancement Engine can be used for retrieving information from disparate information sources 120 based on an information need (e.g., a stimulus 112) and a context 114. First, based on the original query 110 and context 114, QUEEN determines which information source(s) 120 are most appropriate for retrieving the requested information by consulting an information registry.

Once candidate information source(s) 120 have been identified, the query 110 is generated (by the Query Enhancement Engine 115) and passed to the information source 120 for retrieval. Different data repositories (file systems, databases, etc) utilize different mechanisms for retrieving data within them. The information source 120 encapsulates these retrieval mechanisms.

To improve the precision of retrieval results, it is sometimes beneficial to modify the query prior to retrieval. Query enhancement may involve adding additional terms to a query to improve results. Query refinement may involve removing or substituting terms to a query to improve performance. QUEEN 115 may request information using an initial query and then enhance or refine the query to improve performance, for example.

The query 110 is combined with data from the one or more data source 120 and provided to an information composition engine (“ICE”) 125 to compile or bundle data from the data source(s) 120 in response to the query 110. The ICE 125 can bundle information for presentation from multiple, heterogenous data sources 120.

For example, for a given information need, several different types of information may be desirable for the particular task at hand to form a semantically meaningful bundle of information. A bundle includes one or more types of information (e.g., patient history and lab results). Organizing the various informational items into semantic units is referred to as information composition or bundling. The ICE 125 is responsible for composing the retrieved information from the data source(s) 120 together into a bundle that is meaningful to the user. Bundles may be composed based on the semantic needs of the user, and may also be driven by user preferences, and/or other knowledge appropriate to the domain, for example.

In certain embodiments, the ICE 125 uses Composers to compose the information retrieved from the data source(s) 120. Composers employ Composition Decision Logic (“CDL”), for example, to compose the information. Some examples of CDL include aggregation elimination of redundant information, lightweight summarization of information, and fusion of results, for example.

A controller, including an active listener component, for example, can manage the interaction between the QUEEN 115 and the ICE 125. When the QUEEN 115 has retrieved the information, the information is passed to the ICE 125 for composition and bundling before being delivered to the application or user. The active listener component can monitor and react to information retrieved by the QUEEN 115 and passed to the ICE 125, for example.

During composition, it may be determined that some information is missing or insufficient. In this case, the ICE 125 can inform the controller that information is missing/insufficient. The controller can then inform the Query Engine 115 that one or more queries 110 are to be enhanced or refined in order to improve retrieval performance. The query(ies) 110 are performed again and the results are passed back to the ICE 125 for composition and bundling prior to being returned to the user, for example.

The ICE 125 then produces a bundle 130 including relevant information composed and tailored for a requesting user based on context information 114 from the query 110. The bundle 130 is passed to the summarization engine 135. The summarization engine 135 provides multi-document summarization for the content of the bundle 130. Summarization will be described further below.

A revised bundle 140, annotated with summaries from the summarization engine 135, is used to generate a presentation 145. The presentation can include a multimedia bundle of text, video and images returned from a metadata search of the data source(s) 120 and including contextual summaries from the summarization engine 135. A user can drill down into details through the presentation 145. A user, such as a physician and/or nurse, can use information from the presentation 145 to further diagnose and/or treat the patient. A user's reaction and/or other feedback 150 from the presentation 145 information can be provided back to the knowledge management subsystem 160 for subsequent use. In certain embodiments, an active listener component to the knowledge management subsystem 160 updates and/or provides additional content and/or application based on the user reaction/feedback 150, for example.

The knowledge management subsystem 160 will now be described in further detail. The knowledge management subsystem 160 includes one or more tools and/or additional information to assist the query driver 115 to form a query to extract relevant information from the data source(s) 120. Query 110 information, such as stimulus 112 and context 114, can be input to the knowledge management subsystem 160 to provide relevant tools and/or information for the query driver 115. Alternatively and/or in addition, clinician reaction and/or other feedback 150 can be fed back into the subsystem 160 to provide further information and/or improve further results from the knowledge management subsystem 160.

As shown, for example, in FIG. 1, the knowledge management subsystem 160 includes one or more dashboards 161, one or more ontologies 163, procedures and guidelines 165, a common data model 167, and analytics 169. The knowledge management subsystem 160 can provide a Knowledge and Terminology Management Infrastructure (“KTMI”) to the workflow 100. An ontology 163 details a formal representation of a set of concepts within a domain and the relationships between those concepts. The ontology 163 can be used to define a domain and evaluate properties of that domain. The common data model 167 defines relationships between disparate data entities within a particular environment and establishes a context within which the data entities have meaning. The common data model 167 provides a data model that spans applications and data sources in the workflow 100 and defines data relationships and meanings within the workflow 100. Using the analytics 169, for example, the subsystem 160 can access dashboard(s) content 161, ontology(ies) 163, and procedures/guidelines 165 based on a common data model 167 to provide output to the query driver 115.

The activity of summarization engine 135 will now be described in further detail. Multi-document summarization is an automatic procedure aimed at extraction of information from multiple texts written about the same topic (e.g., disease across multiple patients). A resulting summary report allows individual users, such as examining physicians, nurses, etc., to quickly familiarize themselves with information included in a large cluster of documents. Thus, the summarization engine 135 can complement the ICE 125 to summarize and annotate content for ease of reference, for example.

Multi-document summarization creates information reports that are more concise and comprehensive than a review of the raw data. Different opinions are put together and outlined to describe topics from multiple perspectives within a single document. While a goal of a brief summary is to simplify an information search and reduce time by pointing to the most relevant source documents, a comprehensive multi-document summary should itself contain the requested information, hence limiting the need for accessing original files to cases when refinement is required. Automatic summaries present information extracted from multiple sources algorithmically, without any editorial touch or subjective human intervention, in an attempt to provide unbiased results.

However, multi-document summarization is often more complex than summarizing a single document due to thematic diversity within a large set of documents. A summarization technology aims to combine the main document themes with completeness, readability, and conciseness. For example, evaluation criteria for multi-document summarization developed through Document Understanding Conferences, conducted annually by the National Institute of Standards and Technology, can be used.

In certain embodiments, the summarization engine 135 does not simply shorten source texts but presents information organized around key aspects of the source texts to represent a wider diversity of views on a given topic. When such quality is achieved, an automatic multi-document summary can be used more like an overview of a given topic.

Multi-document summary criteria can include one or more of the following: a clear structure, including an outline of the main content, from which it is easy to navigate to full text sections; text within sections is divided into meaningful paragraphs; a gradual transition from more general to more specific thematic aspects; good readability; etc. with respect to good readability, the automatic overview can show, for example, no paper-unrelated “information noise” from the respective documents (e.g., web pages); no dangling references to subject matter not mentioned or explained in the overview; no text breaks across a sentence; no semantic redundancy; etc.

In certain embodiments, a summarization approach includes three steps: 1) segmentation, 2) clustering/classification, and 3) summary generation. An initial text segmentation is performed by dividing or “chunking” a document into paragraphs based on existing paragraph boundaries. Subtitles and one-line paragraphs can be merged, for example. When no paragraph boundaries are present, then chunking can be done by dividing after ever N words (e.g., every 20 words), for example.

For clustering, one or more natural language processing (“NLP”) techniques can be applied to measure similarity between two collections of words, for example. For example, paragraphs including similar strings of words (e.g., N-grams) are identified, and a similarity metric is defined to determine whether two passages are similar. For example, a similarity metric can provide an output resembling a cosine function (e.g., results closer to a value of one indicate greater similarity). Passage similarity scores can be computed for all pairs of passages using these metrics.

In certain embodiments, it is computationally expensive to look at all combinations of clusters when there are many passages. Therefore, clustering can be performed in two steps: seed clustering and classification. In seed clustering, a complete-link algorithm can be used until a target number of clusters are found. For example, a target number of clusters can be equal to log(number of documents). In classification, remaining passages are then classified by finding a best matching seed cluster. If a passage has no similarity, it is placed in a trash cluster.

For summary generation, a most characteristic paragraph is then taken from each cluster to form a “meta document.” A single document summarizer is then used to create a “summary” for the entire collection. The summary is bundled with the information and provided as the bundle 140.

As an example of the workflow 100 in action, suppose that, prior to performing surgery on a patient, a physician wants to know what allergies a patient has. Information about a patient's allergies may be stored in different systems using a combination of document repositories, file systems, and databases 120. Using the ICE 125, a variety of information about the patent's allergies is found and bundled and presented to the physician. Some of the information may be buried within paragraphs in some documents, while other information is found in database tables, for example. When a system's databases have been exposed (e.g., through a Connectivity Framework), the ICE 125 and its QUEEN engine can connect to the database 120 to query for information. When a database is not available for a particular system, the document repository for that system can still be searched. The document summarizer 135 can be used to provide summaries of documents retrieved and to cluster related passages from documents retrieved to pull in related patient information. The information is organized into a bundle 140 before being delivered to the user. The information may be organized based on information type, semantics, information relevance, and the confidence score from the underlying repository, for example.

In certain embodiments, the workflow 100 supports a user by continually searching for relevant information from connectivity framework components using a query generation engine 115. Subsequently, these results are classified and bundled through an information composition engine 125 that transforms the information for appropriate presentation to the user.

In certain embodiment, an adaptive user interface (“UI”) design is achieved by taking advantage of semantic web technology. For example, domain concepts and relationships are characterized in a hierarchy of ontologies, associated with upper level ontological constructs that enable adaptive reasoning and extensibility.

A core ontology can be derived from one or more work-centered design principles. For example, an effective interface can display information that represents a perspective that a user needs on a situated work domain to solve particular types of problems. As another example, information that is the most important to the user in the current work context can be displayed in a focal area to engage the user's attention. Referential information can be offered in a periphery of a display to preserve context and support work management. As a further example, a user's own work ontology (e.g., terms and meaning) should be the primary source for information elements in the interface display.

Thus, certain embodiments provide adaptive user interface capabilities through use of a controller that can “reason” about metadata in an ontology to present users with a work-centered application tailored to individual needs and responsive to changes in the work domain. Such user interface capabilities help obviate problems associated with browsing “external” data that a connectivity framework can access by offering an interface to deliver targeted information in an application context-sensitive manner.

In human-computer interaction, user interface data, events, and frequencies can be displayed, recorded, and organized into episodes. By computing data positioned on a display screen, episode frequencies, and implication relations, application-specific episode associations can be automatically derived to enable an application interface to adaptively provide just-in-time assistance to a user. By identifying issues related to designing an adaptive user interface, including interaction tracking, episodes identification, user pattern recognition, user intention prediction, and user profile update, for example, the interface can act on a user's behalf to interact with an application based on certain recognized plans. To adapt to different users' needs, the interface can personalize its assistance by learning user profiles and disease-specific workflows, for example.

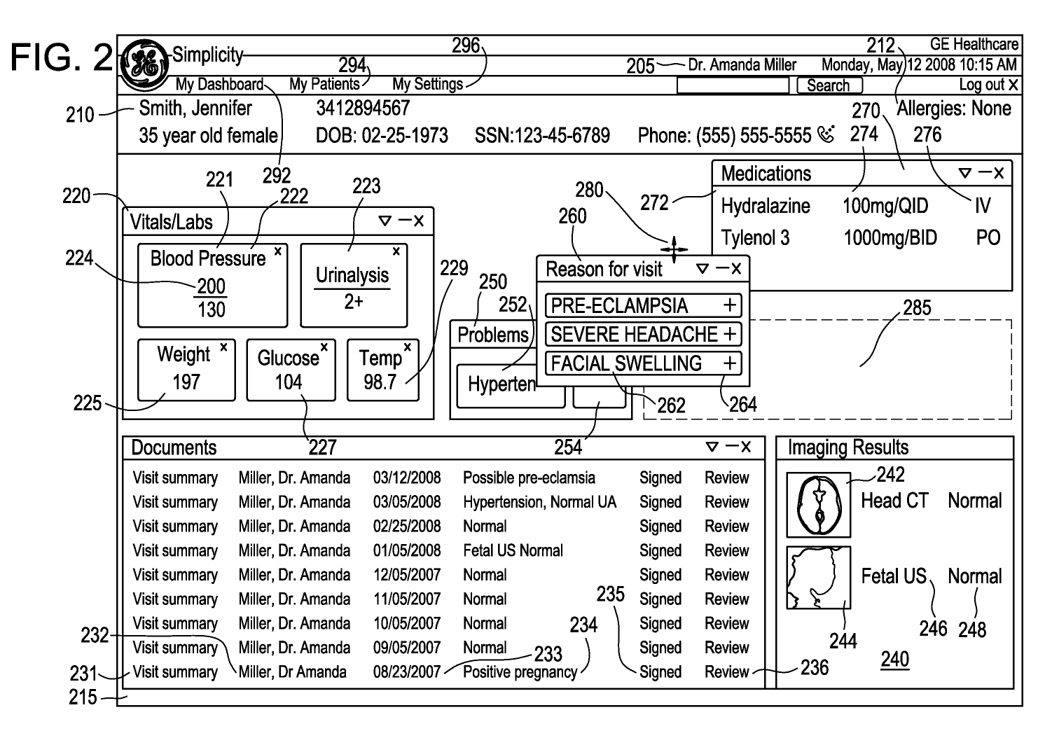

FIG. 2 shows an example adaptive user interface (“UI”) 200 in accordance with an embodiment of the present invention. The UI 200 includes a login and user identification area 205, a patient identification area 210, an alert 212, and a widget display area 215. The user identification area 205 identifies the user currently logged in for access to the UI 200. The patient identification area 210 provides identification information for a target patient, such as name, identification number, age, gender, date of birth, social security number, contact information, etc. The alert 212 can provide patient information for the attention of the user, such as an indication that the patient has no allergies. The widget display area 212 includes one or more widgets positionable by a user for use via the UI 200.

For example, as shown in FIG. 2, the widget display area 212 includes widgets 220, 230, 240, 250, 260, 280. Widgets can provide a variety of information, clinical decision support, search capability, clinical functionality, etc. As shown, for example, in FIG. 2, the widget 220 is a vitals/labs widget. The vitals widget 220 provides a visual indicator of one or more vital signs and/or lab test results for the patient. For example, indicators can include blood pressure 221, urinalysis 223, weight 225, glucose 227, and temperature 229. Each indicator includes a type and a value. For example, the blood pressure indicator 221 includes a type 222 (e.g., blood pressure) and a value 224 (e.g., 200 over 130). Each indicator 221, 223, 225, 227, 229 has a certain color and/or a certain size to indicate an importance of the constituent information from the indicator. For example, the blood pressure indicator 221 is the largest sized indicator in the widget 220, visually indicating to a user the relative importance of the blood pressure reading 221 over the other results. Urinalysis 223 would follow as next in importance, etc. As another example, blood pressure 221 is colored red, urinalysis 223 is colored orange, weight 225 is colored yellow, and both glucose 227 and temperature 229 are colored green. The color can be used to indicate a degree of severity or importance of the constituent value. For example, blood pressure 221, colored red, would carry the most importance, urinalysis 223, colored orange, would be next in importance, etc. Thus, indicator size and/or color can be used together and/or separately to provide the user with an immediate visual indication of a priority to be placed on investigation of patient vitals and lab results. In certain embodiments, selection of an indicator retrieves data, results, and/or document(s) used to generate the information for the indicator.

Widget 230 provides a list of clinical documents related to the patient, such as encounter summaries, reports, image analysis, etc. Document information can include a document type 231, a document author 232, a document date 233, an evaluation from the document 234, a document status 235, and an action for the document 236. For example, an entry in the document widget 230 can be of visit summary type 231, generated by author 232 Dr. Amanda Miller, on a date 233 of Mar. 12, 2008, diagnosing 234 possible pre-eclampsia, with a status 235 of signed, and an action 236 of review. A user can select a document entry to retrieve and display the actual document referenced in the widget 230.

Widget 240 provides one or more imaging studies for review by the user. The imaging studies widget 240 includes one or more images 244 along with an imaging type 246 and an evaluation 248. For example, as shown in FIG. 2, the widget 240 includes a head CT evaluated as normal and a fetal ultrasound image evaluated as normal.

Widget 250 provides a visual representation of one or more problems 252, 254 identified for the patient. Similar to the vitals widget 220, the problem indicators 252, 254 can have a certain color and/or a certain size to indicate an importance of the constituent information from the problem indicator. For example, in the hypertension problem indicator 242 is colored red and is larger than the other problem indicator 254. Thus, indicator size and/or color can be used together and/or separately to provide the user with an immediate visual indication of a priority to be placed on investigation of patient problems. In certain embodiments, selection of a problem indicator retrieves data, results, and/or document(s) used to generate the information for the indicator.

Widget 260 provides one or more reasons for a patient's visit to the user. The reason for visit widget 260 includes a reason 262 and an icon 264 allowing the user to expand the reason 262 to view additional detail or collapse the reason 262 to hide additional detail. The reasons 262 can be color coded like the indicators from widgets 220, 250 to provide a visual indication of priority, significance, severity, etc.

Widget 270 provides a listing of medications prescribed to the patient. The medications widget 270 includes a type 272 of medication, a quantity 274 of the medication, and a delivery mechanism 276 for the medication. In certain embodiments, selection of a medication can pull up further detail about the medication and its associated order, for example.

As shown, for example, in FIG. 2, a user can manipulate a cursor 280 to select a widget and position the widget at a location 285. Thus, a user can select widgets for display and then arrange their layout in the widget display area 215 of the UI 200. Alternatively and/or in addition, the user can reposition widgets in the widget display area 215 to modify the UI 200 layout. For example, using the cursor 280, the user can place the reason for visit widget 260 in a certain spot 285 on the widget display area 215.

The UI 200 can also provide one or more links to other clinical functionality, such as a user dashboard 292, a patient list 294, a settings/preferences panel 296, and the like.

Certain embodiments allow healthcare information systems to find and make use of relevant information across a timeline of patient care. For example, a search-driven, role-based interface allows an end user to access, input, and search medical information seamlessly across a healthcare network. An adaptive user interface provides capabilities through a work-centered interface tailored to individual needs and responsive to changes in a work domain, for example. Semantic technology can be leveraged to model domain concepts, user roles and tasks, and information relationships. The semantic models enable applications to find, organize and present information to users more effectively based on contextual information about the user and task. Components forming a framework for query and result generation include user interface frameworks/components for building applications; server components to enable more efficient retrieval, aggregation, and composition of information based on semantic information and context; and data access mechanisms for connecting to heterogeneous information sources in a distributed environment.

A variety of user interface frameworks and technologies can be used to build applications including, Microsoft® ASP.NET, Ajax®, Microsoft® Windows Presentation Foundation, Google® Web Toolkit, Microsoft® Silverlight, Adobe®, and others. Applications can be composed from libraries of information widgets to display multi-content and multi-media information, for example. In addition, the framework enables users to tailor layout of the widgets and interact with underlying data.

Healthcare information can be distributed among multiple applications using a variety of database and storage technologies and data formats. To provide a common interface and access to data residing across these applications, a connectivity framework (“CF”) is provided which leverages common data and service models (“CDM” and “CSM”) and service oriented technologies, such as an enterprise service bus (“ESB”) to provide access to the data.

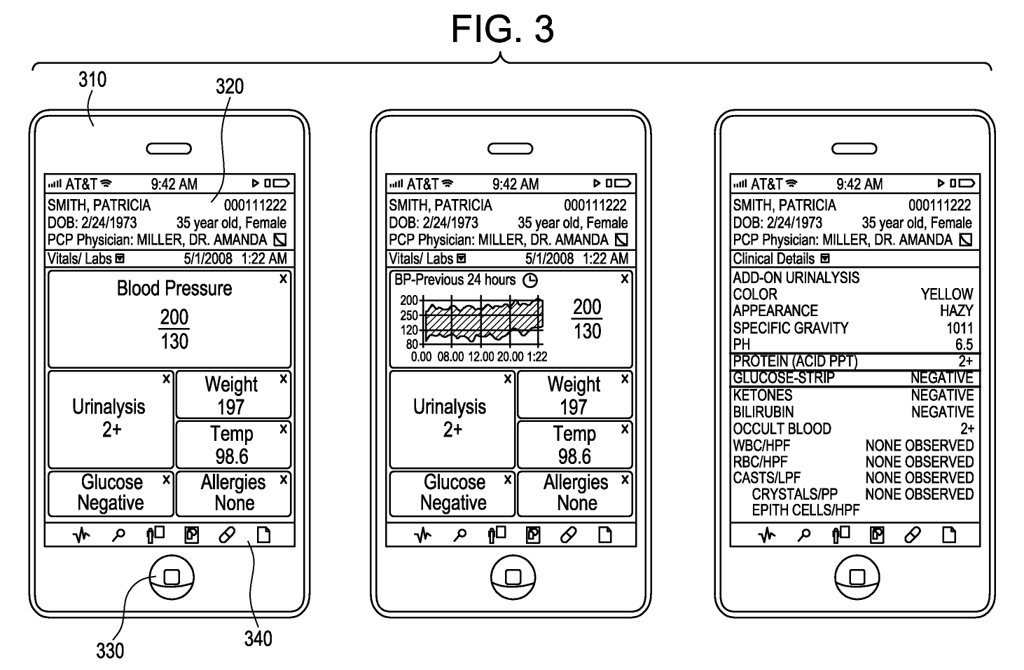

FIG. 3 depicts example mobile devices including a user interface, such as the user interface described in relation to FIG. 2. As shown in FIG. 3, a mobile device 310 can include a graphical user interface 320, a navigation device 330, and one or more tools 340 for interaction with the content of the interface 320, for example. The mobile device 310 can include a cellular phone, personal digital assistant, pocket personal computer, and/or other portable computing device. The mobile device 310 includes a communication interface to exchange data with an external system, for example.

A combination of mobile services and Web services can be used for delivery of information via the mobile device 3 10. Using Mobile Web Technology, portability, ubiquitous connectivity, and location-based services can be added to enhance information and services found on the Web. Applications and various media do not need to reside in separate silos. Instead, applications on these devices 310 can bring together elements of Web 2.0 applications, traditional desktop applications, multimedia video and audio, and the mobile device (e.g., a cell phone), for example. Using an adaptive user interface architecture, widgets can be designed for mobile devices to enable users to create or consume important clinical information whenever and wherever they need it, for example.

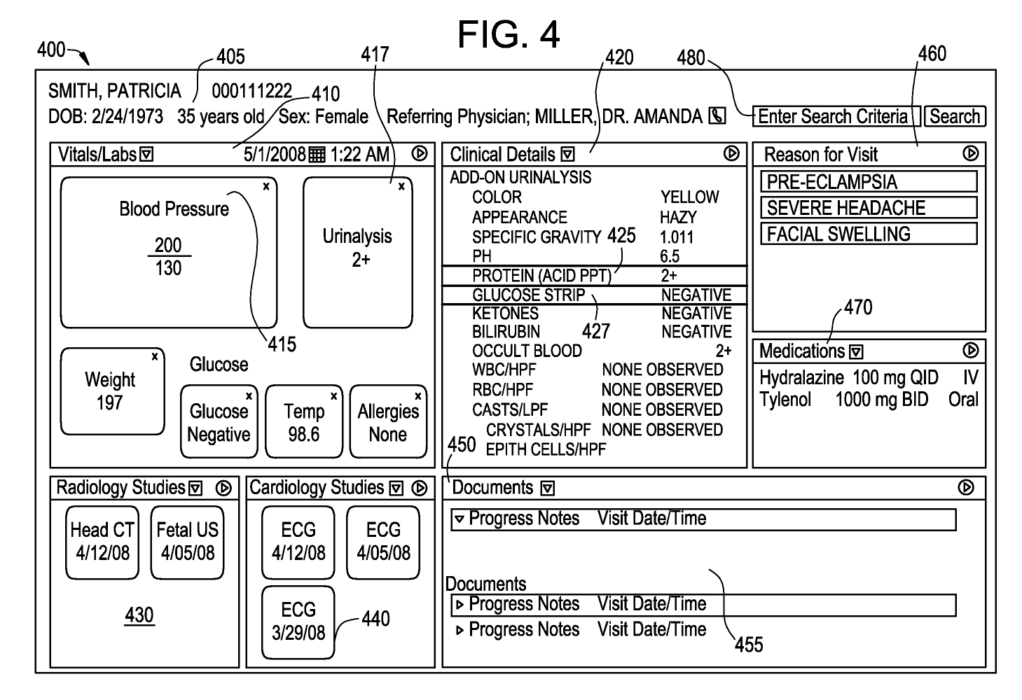

FIG. 4 illustrates an example use case of an adaptive, work-centered user interface 400 in perinatal care in accordance with an embodiment of the present invention. In the example of FIG. 4, Patricia Smith, a 35-year old pregnant female, is in her 34th week of her third pregnancy. Throughout the course of her care, Patricia has had the typical workup, including initial lab studies, vitals, a three-dimensional (“3D”) fetal ultrasound, and other routine tests. With the exception of her gestational diabetes, Patricia has had a normal pregnancy, and all indications are that she'll deliver a healthy baby boy at full term.

At her 34-week appointment, however, Patricia's obstetrician/gynecologist becomes somewhat concerned at her blood pressure, which is high compared to previous readings, at 145/95. Dr. Amanda Miller orders an electrocardiogram (“EKG”) and a urinalysis (“UA”) test. Although Patricia's EKG shows a normal sinus rhythm, her UA comes back with trace amounts of Albumin, suggestive of pre-eclampsia. Dr. Miller asks Patricia to set up her next appointment for one week from today to monitor her blood pressure and kidney function.

The following week, Patricia's blood pressure is higher than the previous value (150/98) and Dr. Miller orders another urinalysis. The UA comes back positive again, but at about the same level as before. Dr. Miller feels it's prudent to continue the weekly visits until her blood pressure comes down to normal levels. She also mentions to Patricia that one warning sign of eclampsia is a sudden, severe headache, and, if she experiences one, she should go directly to the Emergency Department for care.

At her son's fifth birthday party over the weekend, Patricia comes down with a severe headache. Tom, her husband, immediately takes her to the Emergency Department (“ED”) at the local hospital. The ED staff access all of Patricia's medical records via a longitudinal timeline record, for example, and become informed about all of the aspects of her case. With Patricia's blood pressure (“BP”) skyrocketing at 200/130, the ED doc orders a series of tests—UA, EKG, Chem Panel, and a Head CT. Both the Chem Panel and Head CT come back normal but, just as Dr. Miller feared, the UA shows and elevated level of Albumin (2+). Given the result of the tests and Patricia's condition, the ED doc and Dr. Miller decide the best course of action is to deliver the baby via a C-section as soon as Patricia's blood pressure comes under control. She is administered Hydralazine (through her IV) to control the hypertension and Tylenol 3 for her headache, and is transported to surgical holding.

The C-section was a success, and Patricia and Tom are the proud parents of Evan, a six-pound, four-ounce healthy baby boy. After a week's stay, both Patricia and Evan are discharged from the hospital. Both Patricia and Evan are examined a week later at Dr. Miller's office. Patricia's albumin and blood pressure have returned to normal, as has her blood glucose level.

Using the user interface 400, Dr. Miller can easily review, enter, and modify Patricia's progress, lab results, vitals, etc., based on an identification of the patient 405. The UI 400 shows Patricia's vitals 410 and visually indicates through a large, red icon 415 that Patricia's blood pressure is of concern. Additionally, abnormal urinalysis results 417 are visually highlighted to the physician. Clinical details 410 of the urinalysis can be easily reviewed, with key results highlighted to indicate positive 425 or negative 427 results. Dr. Miller can review the radiology 430 and cardiology 440 studies she ordered for Patricia and can check documents 450, including previous progress notes 455 to evaluate Patricia's progress. Dr. Miller (and/or an assisting nurse, for example) can also enter and review Patricia's reasons for visiting the hospital 460. After prescribing the Hydralazine and Tylenol 3, Dr. Miller can verify the dosage and delivery methods and modify them following the C-section via a Medications widget 470. If Dr. Miller has further questions and/or wants to search for additional information, a search field 480 allows her to do so.

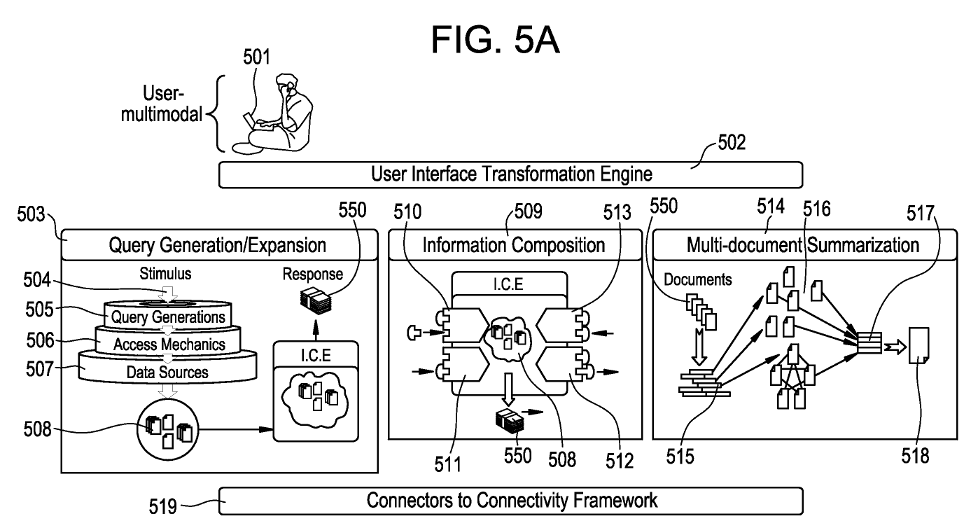

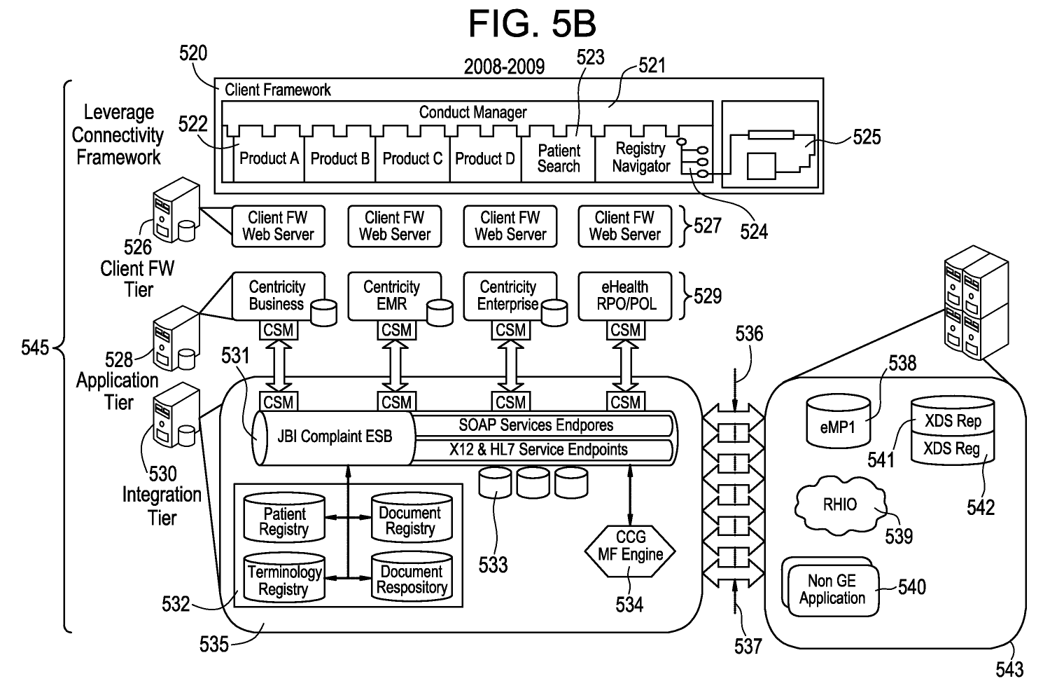

FIG. 5 depicts a user interface architecture 500 in accordance with certain embodiments of the present invention. The architecture 500 includes a user interface transformation engine 502, a query generation/expansion engine 503, an information composition engine 509, a multi-document summarization engine 514, and one or more connectors 519 to a connectivity framework 545. The components of the architecture 500 are accessible by a user via a user interface 501 on a processing device, such as a computer or handheld device. The user can submit a query for information via the user interface 501, for example.

The query generation/expansion engine 503 includes a stimulus 504, one or more query generators 505, and one or more access mechanisms 506 to search one or more data source 507 to produce a query and collected documents 508. The query and collected documents 508 are passed to the information composition engine 509 that includes applications 510, 511, 512, 513 that process and apply cognitive reasoning, for example, to organize the query and collected documents 508 into one or more units meaningful to a requesting user based on one or more of semantic guidelines, user preferences, and domain-related information, for example. A toolset including composers can employ Composition Decision Logic (“CDL”), such as aggregation, elimination of redundant information, lightweight summarization of information, and fusion of results, to compose the information. Applications can include one or more data driven applications 510, enterprise application interfaces 511, task/process driven applications 512, and data structure specific applications 513, for example. The applications 510, 511, 512, and/or 513 can include one or more templates related to new data types, new data structures, domain specific tasks/processes, new application interfaces, etc. Composition and processing of the query and collected documents 508 produces a bundle 550 of information in response to a user query.

The multi-document summarization engine 514 receives the bundle 550 of documents and segments the documents into passages 515. The passages 515 are clustered based on similar concepts 516. A meta-document 517 is then formed from the concepts 516. A summary 518 is generated from the meta-document 517. Query results 550, the meta-document 517, and/or the meta-document summary 518 can be provided to the user via the user interface 501.

Via connectors 519 to a connectivity framework 545, the user interface 501 and its engines 503, 509, 514 can send and receive information in response to user query via the interface 501, for example. For example, the query engine 503 can access the connectivity framework 545 to query one or more data sources 507.

The connectivity framework 545 includes a client framework 520. The client framework 520 includes a context manager 521 for one or more products 522, a patient search 523, a registry navigator 524, and a viewer 525. Thus, in certain embodiments, the connectivity framework 520 can facilitate viewing and access to information via the user interface 501 and apart from the user interface 501. Via the connectivity framework 545, the query engine 503 and/or other parts of the user interface 501 can access information and/or services through a plurality of tiers.

Tiers can include a client framework tier 526, an application tier 528, and an integration tier 530, for example. The client framework tier 526 includes one or more client web servers 527 facilitating input and output of information, for example. The applicant tier 528 includes one or more applications 529 related to enterprise and/or departmental usage such as business applications, electronic medical records, enterprise applications, electronic health portal, etc. The integration tier 530 includes a consolidated interoperability platform server 535 in communication with customer information technology (“IT”) 543 via one or more factory 536 and/or custom 537 interfaces, such as default and/or customized interfaces using a variety of message formats such as a web service (“WS”), X12, Health Level Seven (“HL7”), etc. The consolidated interoperability platform 535 can communicate with the one or more applications 529 in the application tier 528 via a common service model (“CSM”), for example.

As shown, for example, in FIG. 5, the consolidated interoperability platform 535 includes an enterprise service bus (“ESB”) 531, a collection of registries, data, and services 532, configuration information 533, and a clinical content gateway (“CCG”) interface engine 534, for example. The ESB 531 can be a Java business intelligence (“JBI”) compliant ESB, for example. The ESB 531 can include one or more endpoints or locations for accessing a Web service using a particular protocol/data format, such as X12, HL7, SOAP (simple object access protocol), etc., to transmit messages and/or other data, for example. Using a CSM, the ESB 531 facilitates communication with the applications 529 in the application tier 528, for example. Via the ESB 531, information in the registries, data and services repository 532 can be provided to the applicant tier 531 in response to a query, for example. Configuration information 533 can be used to specify one or more parameters such as authorized users, levels of authorization for individual users and/or groups/types of users, security configuration information, privacy settings, audit information, etc. The CCG interface engine 531 receives data from the customer IT framework 543 and provides the data to the registries 532 and/or applications 529 in the application tier 531, for example.

As shown, for example, in FIG. 5, the customer IT 543 includes support for a third party electronic message passing interface (“eMPI”) 538, support for a regional health information organization (“RHIO”) 539, one or more third party applications 540, support for a cross-enterprise document sharing (“XDS”) repository 541, support for an XDS registry 542, and the like. Using customer IT 543 in conjunction with the interoperability platform 535, a RHIO gateway and third party application integration can be provided via one or more interfaces to the connectivity framework 545 and/or the query generation/expansion engine 503 of the user interface 501.

The customer IT framework 543 can be organized to provide storage, access and searchability of healthcare information across a plurality of organizations. The customer IT framework 543 may service a community, a region, a nation, a group of related healthcare institutions, etc. For example, the customer IT framework 543 can be implemented with the RHIO 539, a national health information network (“NHIN”), a medical quality improvement consortium (“MQIC”), etc. In certain embodiments, the customer IT 543 connects healthcare information systems and helps make them interoperable in a secure, sustainable, and standards-based manner.

In certain embodiments, the customer IT framework 543 provides a technical architecture, web applications, a data repository including EMR capability and a population-based clinical quality reporting system, for example. The architecture includes components for document storage, querying, and connectivity, such as the XDS registry 542 and repository 541. In certain embodiments, the XDS registry 542 and repository 541 can include an option for a subscription-based EMR for physicians, for example. In certain embodiments, the XDS registry 542 and repository 541 are implemented as a database or other data store adapted to store patient medical record data and associated audit logs in encrypted form, accessible to a patient as well as authorized medical clinics. In an embodiment, the XDS registry 542 and repository 541 can be implemented as a server or a group of servers. The XDS registry 542 and repository 541 can also be one server or group of servers that is connected to other servers or groups of servers at separate physical locations. The XDS registry 542 and repository 541 can represent single units, separate units, or groups of units in separate forms and may be implemented in hardware and/or in software. The XDS registry 542 and repository 541 can receive medical information from a plurality of sources.

Using an XDS standard, for example, in the customer IT framework 543, document querying and storage can be integrated for more efficient and uniform information exchange. Using the customer IT 543, quality reporting and research may be integrated in and/or with an RHIO 539 and/or other environment. The customer IT 543 can provide a single-vendor integrated system that can integrate and adapt to other standards-based systems, for example.

Via the customer IT framework 543, a group of EMR users may agree to pool data at the XDS registry 542 and repository 541. The customer IT framework 543 can then provide the group with access to aggregated data for research, best practices for patient diagnosis and treatment, quality improvement tools, etc.

XDS provides registration, distribution, and access across healthcare enterprises to clinical documents forming a patient EMR. XDS provides support for storage, indexing, and query/retrieval of patient documents via a scalable architecture. Certain embodiments, however, support multiple affinity domains (defined as a group of healthcare enterprise systems that have agreed upon policies to share their medical content with each other via a common set of policies and a single registry) such that each affinity domain retains its autonomy as a separate affinity domain but shares one instance of hardware and software with the other involved affinity domains. The XDS registry 542 and repository 541 can maintain an affinity domain relationship table used to describe clinical systems participating in each affinity domain. Once a request for a document is made, the source of the request is known and is used to determine which document(s) in the repository 541 are exposed to the requesting user, thus maintaining the autonomy of the affinity domain.

In certain embodiments, the XDS registry 542 and repository 541 represent a central database for storing encrypted update-transactions for patient medical records, including usage history. In an embodiment, the XDS registry 542 and repository 541 also store patient medical records. The XDS registry 542 and repository 541 store and control access to encrypted information. In an embodiment, medical records can be stored without using logic structures specific to medical records. In such a manner the XDS registry 542 and repository 541 is not searchable. For example, a patient's data can be encrypted with a unique patient-owned key at the source of the data. The data is then uploaded to the XDS registry 542 and repository 541. The patient's data can be downloaded to, for example, a computer unit and decrypted locally with the encryption key. In an embodiment, accessing software, for example software used by the patient and software used by the medical clinic performs the encryption/decryption.

In certain embodiments, the XDS registry 542 and repository 541 maintain a registration of patients and a registration of medical clinics. Medical clinics may be registered in the XDS registry 542 and repository 541 with name, address, and other identifying information. The medical clinics are issued an electronic key that is associated with a certificate. The medical clinics are also granted a security category. The security category is typically based on clinic type. In certain embodiments, the requests and data sent from medical clinics are digitally signed with the clinic's certificate and authenticated by the XDS registry 542 and repository 541. Patients may be registered in the XDS registry 542 and repository 541 with a patient identifier and password hash. Patients may also be registered in the XDS registry 542 and repository 541 with name, address, and other identifying information. Typically, registered patients are issued a token containing a unique patient identifier and encryption key. The token may be, for example, a magnetic card, a fob card, or some other equipment that may be used to identify the patient. A patient may access the XDS registry 542 and repository 541 utilizing their token, and, in an embodiment, a user identifier and password.

In certain embodiments, design of the user interface architecture 500 is guided by a plurality of factors related to the interactive nature of the system. For example, one factor is visibility of system status. The system can keep users informed about what is going on through appropriate feedback within reasonable time. Additionally, another factor is a match between the system and the “real world.” The system can speak the user's language, with words, phrases and concepts familiar to the user, rather than system-oriented terms. For example, information can follow real-world conventions and appear in a natural and logical order. Additionally, with respect to consistency and standards, users should not have to wonder whether different words, situations, or actions mean the same thing. The interface architecture can follow platform conventions, for example.

Another example factor relates to user control and freedom. Users often choose system functions by mistake and need a clearly marked “emergency exit” to leave the unwanted state without having to go through an extended dialogue. Certain embodiments support undo and redo operations related to configuration of system parameters and information query, for example.

Another factor is error prevention. Error-prone conditions can be eliminated, or the system can check for error conditions and present users with a confirmation option before a remedial action is executed. Additionally, certain embodiments can help users recognize, diagnose, and recover from errors. Error messages can be expressed in plain language (e.g., no codes), precisely indicate the problem, and constructively suggest a solution, for example. Even though it is better if the system can be used without documentation, it may be necessary to provide help and documentation. Any such information can be easy to search, focused on the user's task, list concrete steps to be carried out, and not be too large, for example.

With respect to ease of user interaction, the system can reduce or minimize the user's memory load by making objects, actions, and options visible. The user should not have to remember information from one part of the dialogue to another. Instructions for use of the system can be visible or easily retrievable whenever appropriate. Further, accelerators, often unseen by a novice user, can often speed up interaction for an expert user such that the system can cater to both inexperienced and experienced users. In certain embodiments, users can tailor frequent actions. Additionally, displayed dialogues can be configured not to include information that is irrelevant or rarely needed. Every extra unit of information in a dialogue competes with the relevant units of information and diminishes their relative visibility.

Certain embodiments provide visualization strategies with a graphical user interface for disparate data types across large clinical datasets across an enterprise. Thus, design elements can include, for example, institutional components, a single point of access search, one or more components/widgets, one or more medical records grids/forms, scheduling, clinical data results, graphs, task lists, messaging/collaboration components, multi-scale images (e.g., deep zoom), one or more external components, mail, RSS feeds, external Web-based clinical tools (e.g., WebMD), etc. Server components can include, for example, a search engine, a Web server, an active listener, an information composition engine, a query engine, a data aggregator, a document summarizer, profile context management, one or more dashboards (e.g., clinical and administrative), etc.

In conjunction with and/or apart from the interface systems described above, a longitudinal health record for one (or several) patients can be generated and displayed for user interaction.

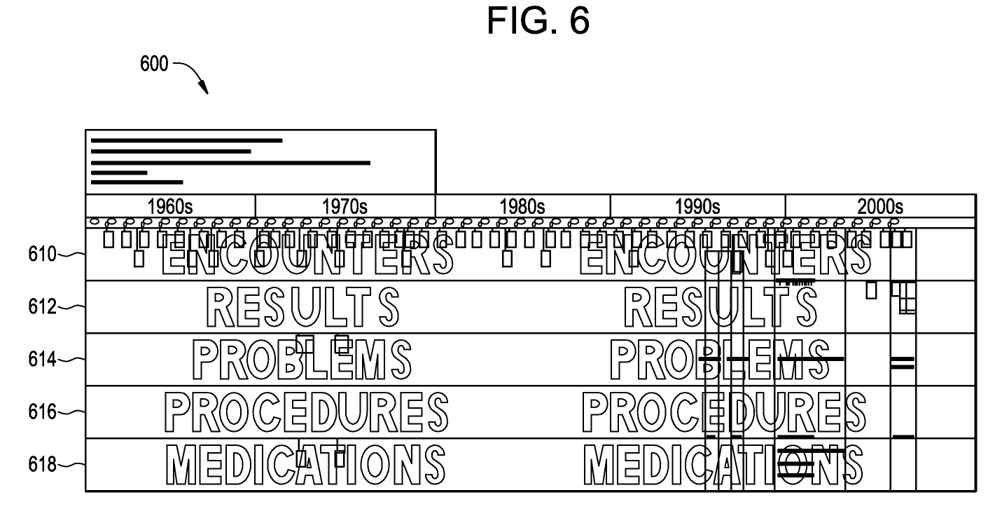

FIG. 6 depicts a complete visualization of an exemplary 44 year old male's complete medical record in accordance with an embodiment of the present invention. At a high level, a user can see each clinical encounter, lab result, report, etc., that exists for the patient. From the high level view, an overall health of a patient can be assessed with specific visual queues that indicate specific problems or events that have occurred for the patient, for example. Rather than interviewing a patient to rely on memory for the granularity of information, a provider has the entire patient context available for assessment via a timeline-based interface. Information can be segmented in a variety of categorizations, for example. For purposes of illustration only, FIG. 6 segments information into Encounters, Results, Problems, Procedures and Medications.

As discussed above, FIG. 6 shows a high level view of a patient timeline displayed graphically for a user. All information for the patient is contained in one context. Patient data is organized by time and correlated with other patient data. A user can view and edit data within the timeline interface.

A user may navigate, manipulate and view different information and different levels/granularity of information in the interface by dragging, scrolling and/or otherwise moving a viewpoint via mouse and cursor, keyboard, trackball, touch screen, etc. The patient timeline may be displayed on a computer monitor, an overhead display, a grease board, a viewing table, etc. In certain embodiments, a viewing table or display projects or otherwise displays the patient history on the table for viewing by a user. In certain embodiments, the viewing surface is touch sensitive and/or associated with motion tracking capability to allow a user to navigate, view and/or modify information in the patient history. In certain embodiments, user(s) actions are detected and tracked by one or more sensors position with respect to the user and with respect to the viewing surface, for example. In certain embodiments, one or more users may view and/or modify information in the timeline simultaneously or substantially simultaneously.

At higher magnification, greater details of the patient start becoming clearer. Based on particular events or problems, the user may choose to zoom in further for greater detail. Further magnification allows greater detail for a particular patient event or source of information. Information displayed may have hyperlinks attached to allow the user to navigate to an information system that initially generated the data to drill down on finer details. Alternatively and/or in addition, finer details related to the information may be present in the patient history context and become viewable and reviewable as the user drills down into the timeline.

In certain embodiments, at higher levels of magnification, additional text becomes more legible and allows a user to view finer detail regarding a particular problem, intervention, report, etc. At even higher magnifications, a user may review and edit data points. Users may annotate relationships of metadata as the metadata pertain to a particular patient being displayed. For example, a user may draw lines to connect problems or circles to group a number of data points to allow a user to visualize relationships and create links to help guide a decision making process.

Users may also review and/or edit specific lab results, childhood immunizations, specific treatment plans, etc. Certain areas of a patient record can be tagged or bookmarked to allow a user to easily drill down to a specific problem or event upon future access, for example.

Thus, certain embodiments allow healthcare providers to see a patient's entire medical record at a single glance. Users are provided with an ability to interactively review information that is relevant to a patient and ignore events or problems that may not be relevant to a current situation. In certain embodiments, hyperlinks allow users to launch and/or access information systems that have more detailed and/or additional documentation that may include radiology images, waveforms, etc. In certain embodiments, addition information from disparate information systems is aggregated into the record for access within the record based on further magnification and “drilling down” into finer levels of granularity within the displayed record. Certain embodiments provide a single repository for patient data that helps provide patients an ability to own, transport and share their own data. Certain embodiments aggregate a patient's lifetime healthcare record in a single context and provide an ability to review the entire dataset at a single glance (e.g., from a single display or interface). In certain embodiments, a lifetime patient healthcare record may be stored on a smart card, thumbdrive, CD, DVD, hard drive, portable memory and/or other medium, for example. Data may be aggregated and stored for later use, for example.

As illustrated, for example, in FIG. 6, a complete patient timeline 600 can be viewed from a high level. The timeline 600 can be divided into a plurality of categories, such as encounters 610, results 612, problems 614, procedures 616 and medication 618. Using the timeline 600, a high level visualization of encounters/visits and results/data can be viewed for a patient lifetime.

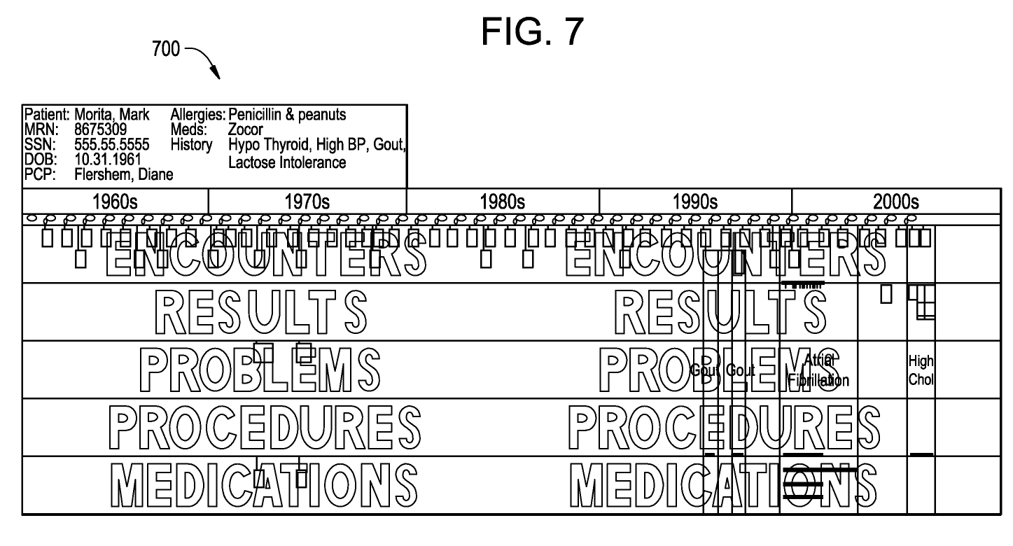

As shown in FIG. 7, for example, a magnification of all or part of a patient record timeline 700 provides additional information regarding patient data points, such as events, problems, reports, etc. For example, in the interface 700 shown in FIG. 7, patient data 720, such as gout, atrial fibrillation, high cholesterol, etc., become legible and/or otherwise visible on the patient record at a point or point(s) in time at which the event or condition occurred, for example.

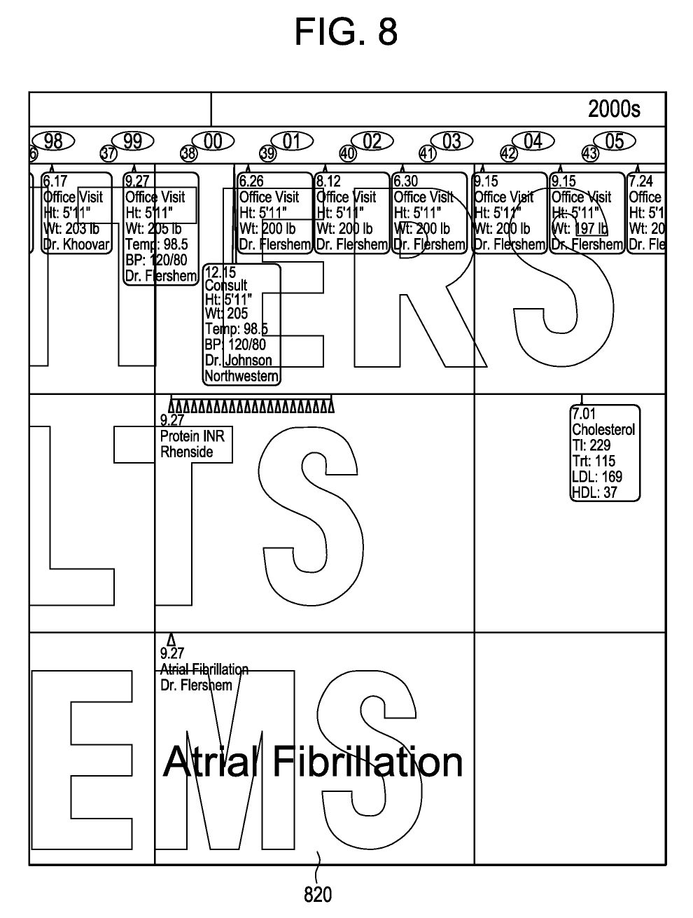

As depicted in FIG. 8, a user can further magnify a particular event to view greater detail regarding an event 820 and surrounding data. A user can select and/or further magnify information displayed to access additional detail and/or connect to an information system including additional detail regarding the selected data point, for example.

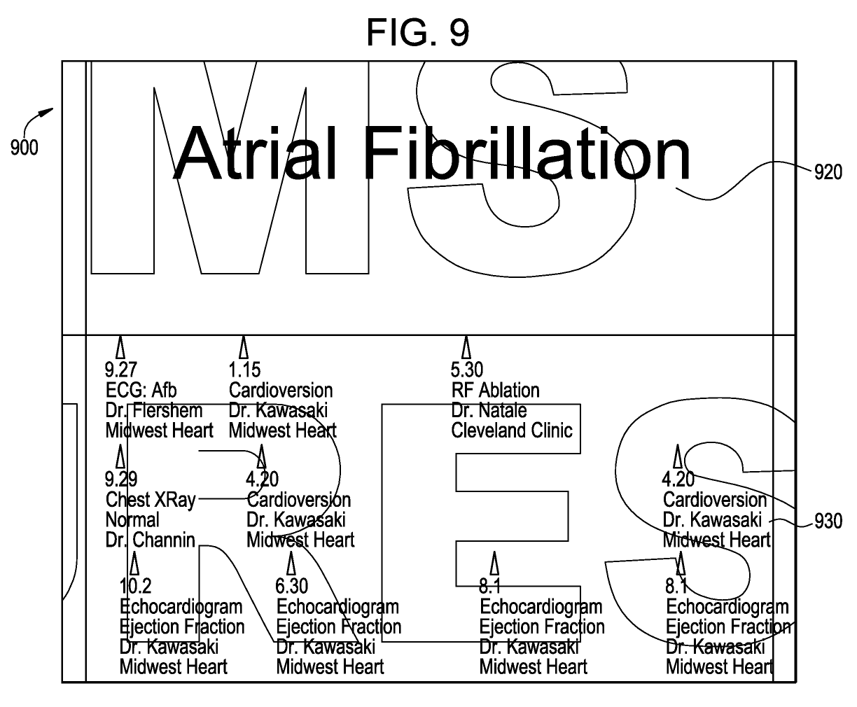

FIG. 9 illustrates a further magnification of a patient record 900 according to an embodiment of the present invention. Further magnification allows a user to view finer detail in conjunction with a problem or intervention. For example, a user can view test(s), procedure(s), and/or examination(s) 930 saved with respect to a particular patient problem 920, such as atrial fibrillation.

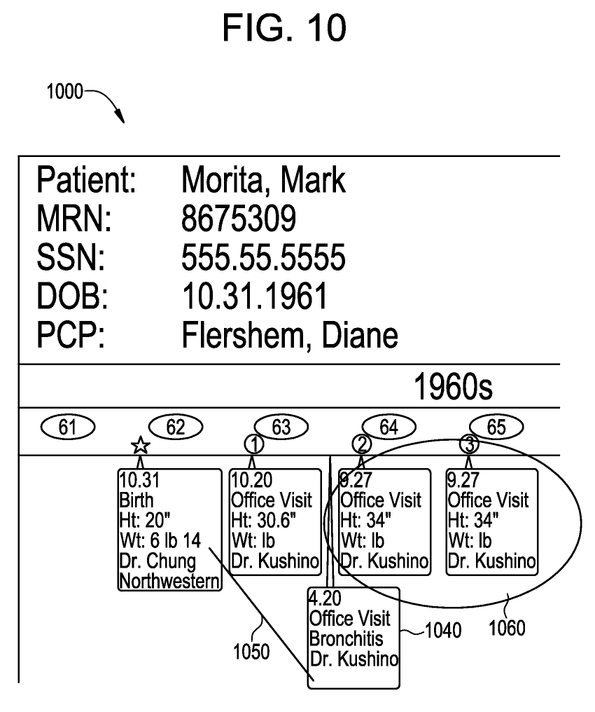

In FIG. 10, further magnification of a patient record timeline 1000 allows a user to review and edit one or more data points 1040 in the record 1000. For example, a user can annotate the record 1000 with one or more lines 1050 and/or other indicia to connect problems, issues, important formation related information, and/or other data points. A user can also circle 1060 one or more data points to create a relationship between those data points. Further annotations can allow a user to highlight, tag and/or otherwise add information to the record 1000 and/or one or more component data points to aid in patient diagnosis, treatment and/or study, for example.

In certain embodiments, a patient medical record aggregated information from a plurality of information systems under a common patient context. Information systems can include a radiology information system (“RIS”), a picture archiving and communication system (“PACS”), Computer Physician Order Entry (“CPOE”), an electronic medical record (“EMR”), Clinical Information System (“CIS”), Cardiovascular Information System (“CVIS”), Library Information System (“LIS”), and/or other healthcare information system (“HIS”), for example. An interface facilitating access to the patient record can include a context manager, such as a clinical context object workgroup (CCOW) context manager and/or other rules-based context manager. Components can communicate via wired and/or wireless connections on one or more processing units, such as computers, medical systems, storage devices, custom processors, and/or other processing units. Components can be implemented separately and/or integrated in various forms in hardware, software and/or firmware, for example.

Certain embodiments can be used to provide an integrated solution for application execution and/or information retrieval based on rules and context sharing, for example. For example, context sharing allows information and/or configuration options/settings, for example, to be shared between system environments. Rules, for example, can be defined dynamically and/or loaded from a library to filter and/or process information generated from an information system and/or an application.

Information for a particular patient can be extracted and/or linked from one or more information systems for presentation to a user via a unified patient record timeline, for example. In certain embodiments, information retrieval, display and/or processing settings, for example, can be customized according to a particular user or type of user. Retrieval, aggregation, display and/or processing of information may be based on rules, preferences, and/or other settings, for example. Rules, preferences, settings, etc. can be generated automatically based on preset parameters and/or observed data, for example. Rules, preferences, settings, etc., can be created by a system administrator or other user, for example. Rules, preferences, settings, etc., also can be manually and/or automatically adapted based on experiences, for example.

In certain embodiments, a user can log on any one of the connected systems and/or a separate system to access information found on all of the connected systems through context sharing and a unified user interface. In certain embodiments, information may be filtered for easier, more effective viewing.

In certain embodiments, a user interface providing a patient record can work together with a perspectives management system for handling multiple applications and workflow, for example. The perspectives management system allows various perspectives to be defined which save workflow steps and other information for a particular user. Perspectives can be used to save visual component positioning information and interactions based on workflow, for example. Perspectives allow relevant information to be presented to a user.

In certain embodiments, a patient record provides identification information, allergy and/or ailment information, history information, orders, medications, progress notes, flowsheets, labs, images, monitors, summary, administrative information, and/or other information, for example. The patient record can include a list of tasks for a healthcare practitioner and/or the patient, for example. The patient record can also identify a care provider and/or a location of the patient, for example.

In certain embodiments, an indication can be given of, for example, normal results, abnormal results, and/or critical results. For example, the indication can be graphical, such as an icon. The user can select the indicator to obtain more information. For example, the user may click on an icon to see details as to why a result was abnormal. The user can be able to view only certain types of results. For example, the user can view only critical results.

Filters and/or rules can be provided for views and/or categories. Ranges, such as values or dates, can be specified for data. Default views, categories, filters, rules, and/or ranges can be provided. In certain embodiments, default values can be modified by a user and/or based on operating conditions. In certain embodiments, new views, categories, filters, rules, ranges, etc., can be created by a user.

For example, a filter can be used to filter medical results data presented to a user according to one or more variables. For example, when a filter is selected by a user, a modification routine applies the filter to the results displayed to the user in the current view by removing from display all medical results that do not fall within the filter. As described above, a variable can be any data or information included in medical data. For example, a variable can include one or more of a type (or item) and/or range of laboratory test results, vital sign measurements, fluids administered to a patient, and/or fluids measured from a patient. A variable can include text from notes, laboratory reports, examination reports, one or more captions to a laboratory test result, vital sign measurement, and/or fluids administered to/measured from a patient, an order for a laboratory test, treatment and/or prescription, and/or a name. By specifying one or more limits on one or more variables, a user can create a filter to be applied to results presented in a results window.

In certain embodiments, a unified user interface is in communication with one or more applications and/or information systems, for example. The unified user interface interacts with individual interfaces for the application(s) and/or system(s) and masks or hides the individual interfaces from a user. That is, the user sees and interacts with the unified user interface rather than the underlying individual interfaces. A user can be authenticated at the unified user interface. Authentication at the unified user interface may propagate through the connected application(s) and/or system(s), for example.

Thus, a patient health record view, such as the interface depicted in FIGS. 6-10, can be provided in conjunction with a user interface, such as the interface 200, 400 (e.g., a Web- and/or application-based user interface). For example, the interfaces of FIGS. 6-10 can be provided as a widget via the interface 200, 400. Using the longitudinal health record of FIGS. 6-10, a user can quickly scan a macro view of a patient history and then dive deep into a specific encounter efficiently.

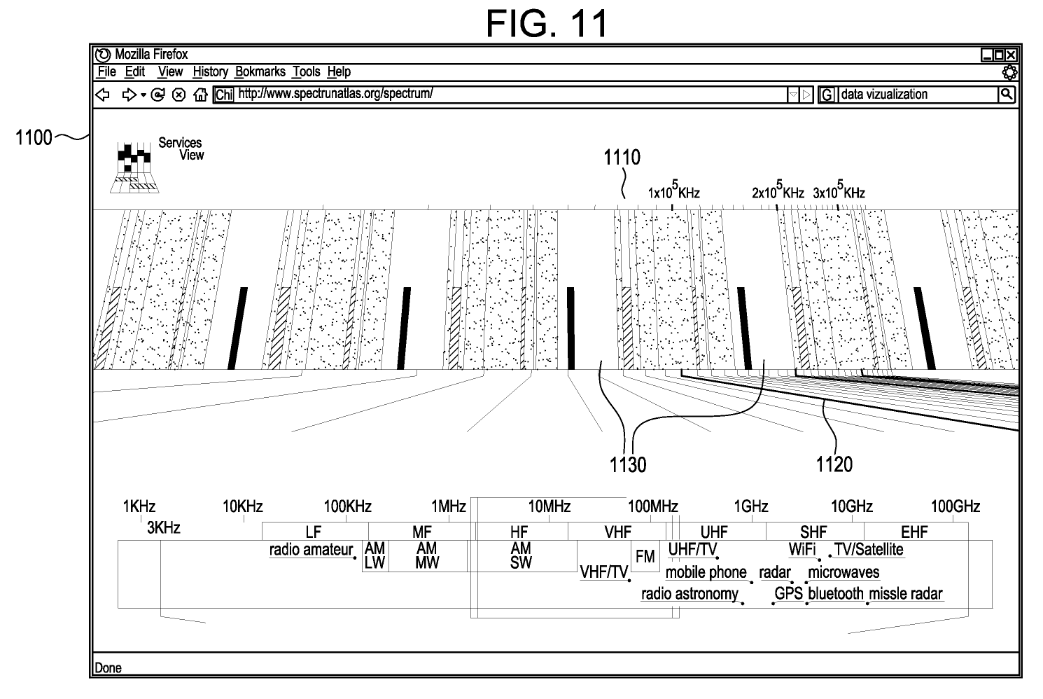

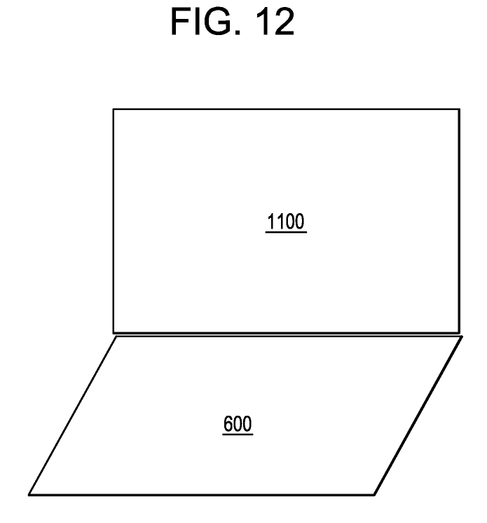

Additionally, FIG. 11 depicts an example of a longitudinal health record 1100 including three-dimensional (“3D”) spectrum representation 1110 of patient information. The spectrum 1110 can be used to represent patient data for one patient and/or for multiple patients, for example. The 3D navigable representation 1110 of patient clinical information uses a graphical representation akin to an electromagnetic radio spectrum to graphically represent different types of patient information. A “services” view 1110 shows a range of clinical information including patient vitals, laboratory results, diagnoses, etc. A “projects” view 1120 delineates different encounters and/or dates during which the data of the services view 1110 was obtained (e.g., a patient clinic visit where a physical examination was conducted and blood was drawn for testing).

Data visualization provided by the spectrum view 1110 is well suited for displaying and quickly navigating dense data that spans a long period of time. The spectrum 1110 also has an advantage of displaying data with clinically relevant normal range values. Data types that can be displayed using this type of visualization include lab values, medications, vital signs, episodic care events, problems, immunizations, allergies, and procedures that span individual patient encounters in a longitudinal format, for example.

In certain embodiments, a user can select a certain data element 1130, and corresponding data elements 1130 are highlighted through the patient record timeline 1110. Highlighting similar data elements 1130 across time via the timeline 1110 helps identify and accentuate a frequency of similar out-of-range data elements (e.g., anomalies in clinical data over time), for example. This type of view provides improved insight into causal function(s) of underlying pathologies, for example. Rather than focusing only on event or encounter based organization, the record 1100 facilitates navigation of a patient record by clinical element and/or by patient encounter, for example.

Certain embodiments allow the user to view data from a macro view (e.g., across an entire patient record) to a micro view (e.g., focusing on an individual data element). Data elements 1130 can be identified by a color and/or surface area based on data element type and value compared to a normal value (e.g., an urgency or severity), for example.

In one example, upon a mouse-over and/or other cursor positioning with respect to a particular data element 1130, other data element(s) 1130 of the same type are highlighted across an entire patient record 1110 (e.g., patient glucose levels over time across multiple patient-physician encounters). By clicking on and/or otherwise selecting a data point 1130 on the timeline 1110, the system 1100 can display an original data source complete with a full data context, for example.

In certain embodiments, the view 1110 allows a user to visually correlate chronic issues directly with data elements 1130 along a clinical data elements axis 1110. A user can position a cursor over an element 1130 (e.g., a mouse over) to be display a summary view of that element 1130 or issue to date, for example. A user can select the element 1130 (e.g., via a mouse click) to display a source document, a list of clinical documents related to the element or issue, and supplemental research material, for example.

As shown in FIG. 12, a spectrum view 1100 of clinical data elements can be combined with a longitudinal, encounter-based patient record 600,700 to form a 3D patient health record interface searchable by both encounter and data type, for example.

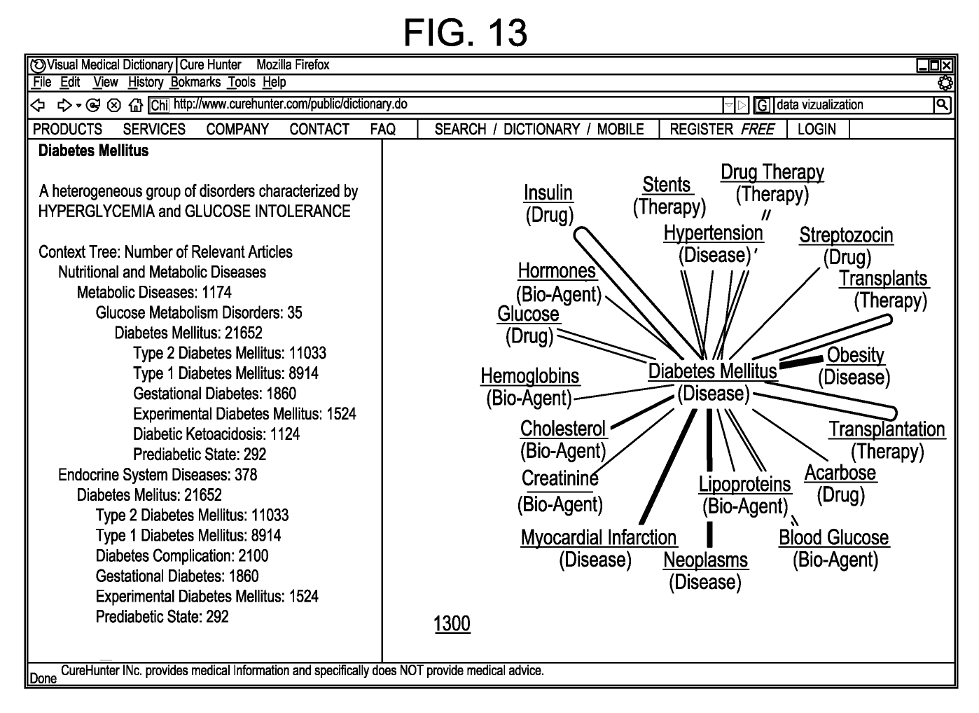

FIG. 13 illustrates an alternative clinical information display 1300 provides names, colors, and links aiding a user in seeing connections between chronic diseases, medications, and treatment protocols, for example. The network visualization 1300 illustrates relationships between diseases, medications/treatments, bio-agents, etc. A color can be used to indicate a type, and an edge thickness can reflect a strength of a relationship between items. Alpha-transparency can indicate a positive outcome score (e.g., darker is more positive), for example.

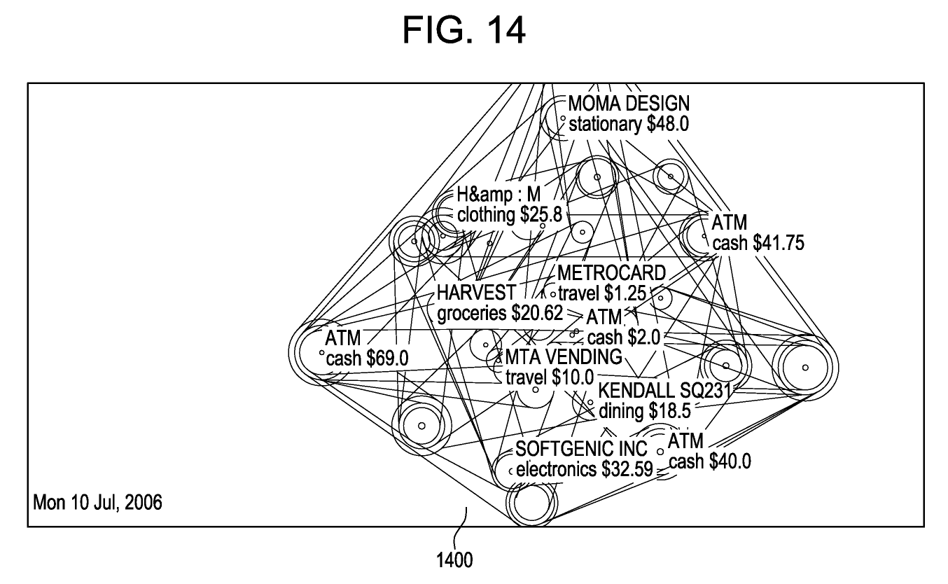

FIG. 14 shows a network turbulence graph 1400 displaying relationships between discrete but disparate data types. The graph 1400 provides a model of dynamic relationships between clinical items and their effects over time, for example. Nodes in the graph 1400 represent events and their connection through categories and dates, for example.

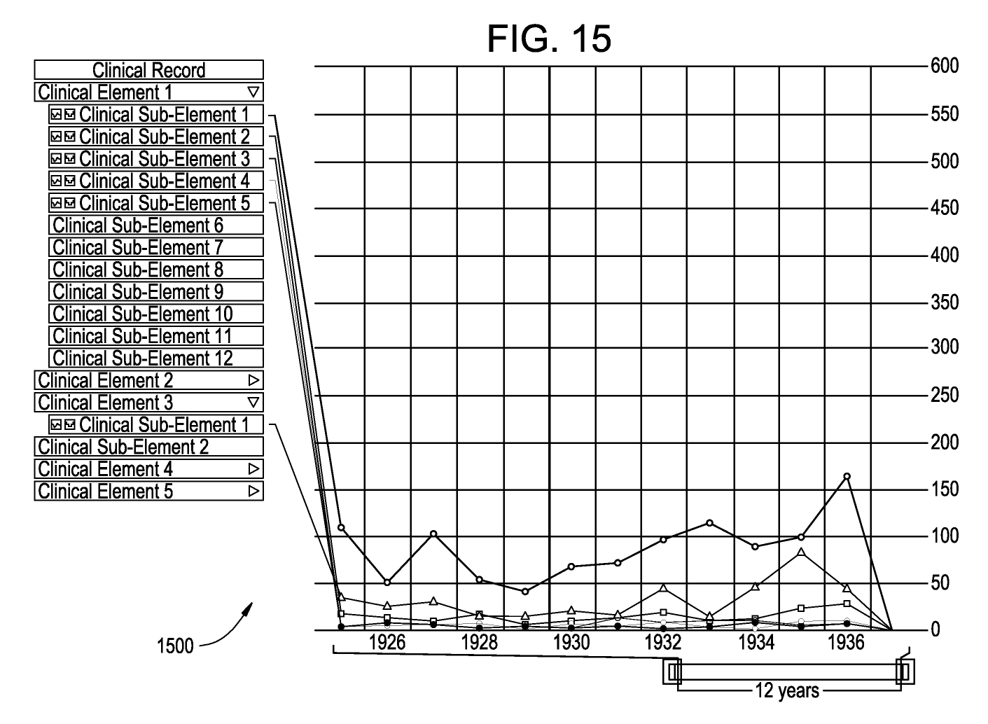

FIG. 15 shows a trending graph 1500 for interactive timeline visualization over the course of a patient's history, combining variables include gender, place of origin, etc. The graph 1500 can be provided by a real-time configurable graphing widget that displays any data type that benefits from a trending view. Showing labs, meds, vitals, inputs and outputs, and being able to compare these variables over time can lead to better, individualized treatment, for example.

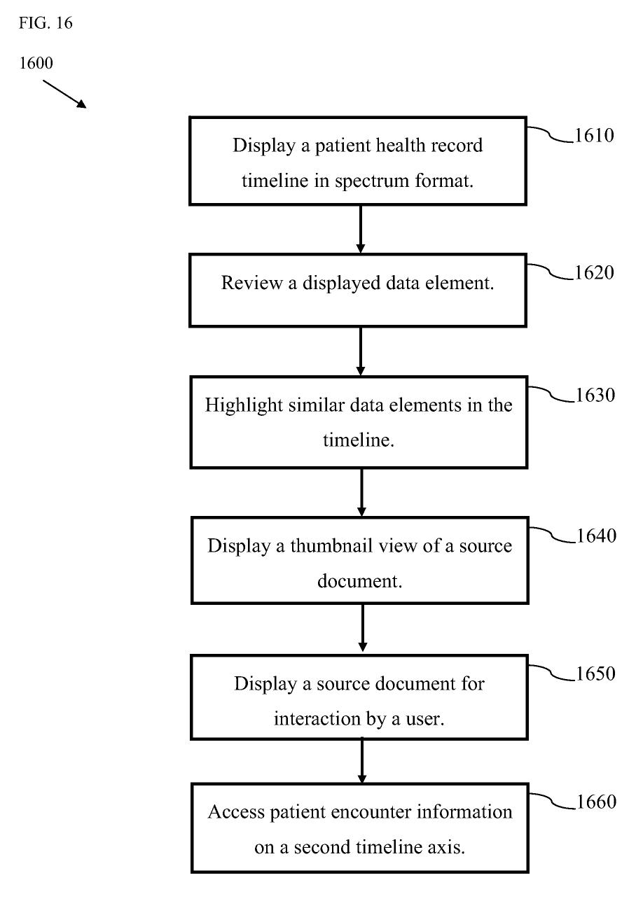

FIG. 16 shows a flow diagram for a method 1600 for interactive, multi-axis longitudinal health record display in accordance with certain embodiments of the present invention.

At 1610, a patient health record timeline is displayed in spectrum format representing a plurality of clinical data elements for the patient. For example, data such as lab values, medications, vital signs, episodic care events, problems, immunizations, allergies, and procedures that span individual patient encounters in a longitudinal format, is displayed as different spectral signal areas for review and selection by a user.

At 1620, a user reviews a displayed data element. For example, a color and/or size/area of a displayed data element can indicate a type, severity, etc., associated with that data element.

At 1630, the user positions a cursor over a particular displayed data element to highlight related or similar data elements. For example, mousing over an x-ray image exam data element highlights other x-ray images obtained during the patient's lifetime.

At 1640, the user positions the cursor over the particular displayed data element to display a thumbnail view of a document corresponding to the displayed data element. For example, mousing over a lab report data element displays a thumbnail or snapshot of that lab report.

At 1650, the user selects the particular displayed data element to display a source document corresponding to the displayed data element. For example, clicking on the lab report data element retrieves and opens a copy of the source lab report for user review and/or edit.

At 1660, a second axis providing patient encounter information is accessed by the user. For example, a patient hospital visit can be selected to view information generated during that visit in an encounter-based format.

One or more of the steps of the method 1600 may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device.

Certain examples may omit one or more of these steps and/or perform the steps in a different order than the order listed. For example, some steps may not be performed in certain examples. As a further example, certain steps may be performed in a different temporal order, including simultaneously, than listed above.

Thus, certain embodiments provide a plurality of benefits including a single point of access, cross-modality data access, XDS compliance, push and pull capability, consensus building, transparency, knowledge management enhanced by use, cross platform (Web, mobile, etc.) accessibility, and a system level view of a user's information space, for example.

Certain embodiments provide an architecture and framework for a variety of clinical applications. The framework can include front-end components including but not limited to a Graphical User Interface (GUI) and can be a thin client and/or thick client system to varying degree, which some or all applications and processing running on a client workstation, on a server, and/or running partially on a client workstation and partially on a server, for example.

The example user interface systems and methods described herein can be used in conjunction with one or more clinical information systems, such as a hospital information system (“HIS”), a radiology information system (“RIS”), a picture archiving and communication system (“PACS”), a cardiovascular information system (“CVIS”), a library information system (“LIS”), an enterprise clinical information system (“ECIS”), an electronic medical record system (“EMR”), a laboratory results/order system, etc. Such systems can be implemented in software, hardware, and/or firmware, for example. In certain implementations, one or more of the systems can be implemented remotely via a thin client and/or downloadable software solution. Furthermore, one or more components can be combined and/or implemented together.

In certain embodiments, an active listener agent operates in a foreground and/or background of a computing device and/or software application, such as a user interface, to monitor user and program activity. For example, the active listener agent can gather information related to widgets in a user interface. The active listener agent can gather information related to actions generated by a user with respect to the user interface and its content, for example.

In certain embodiments, based on application (e.g., widget) information and user interaction, the active listener agent can identify information and/or functionality important to a user based on a current context. In an embodiment, if the active listener agent detects that one or more data elements displayed on a user interface reach a predetermined threshold, the active listener automatically places one or more widgets on the user interface that include additional relevant information to help enable the user to make a well-informed decision. In another embodiment, the active listener agent can help the user by reacting to the user's interaction with an application and provide additional insight by displaying additional information in the form of widget(s) and/or other information on a displayed user interface as a result of the user's actions. For example, if the user drags a certain data element from one widget to another widget (e.g., via cursor selection of the element and movement across a displayed interface using a mousing device), the active listener agent can reposition (e.g., size and/or location) that information on the displayed interface so that an arrangement of data elements signifies a different level of information useful in helping the user arrive at a conclusion (e.g., regarding diagnosis and/or treatment of a patient). The active listener agent can then either place a pre-made relevant widget on the interface that could be helpful a the particular scenario and/or can create a new widget based on the content of the widget the user changed in addition to the data context on the user interface.

Rather than focus on pre-determined workflows, the active listener provides a user with additional information helpful to the user in certain situations where there is no known workflow or protocol. Based on historical data and/or other input, the system displays additional information and/or functionality to the user that is relevant to the user to make an informed decision. In the background of an application and/or interface, for example, the active listener can monitor activity of data elements on a displayed interface. When these data elements reach a certain threshold, the active listener places additional information on the displayed interface to help the user make an informed decision. Alternatively or additionally, the active listener can detect when the user makes a change to an application (e.g., by dragging and dropping a data element from on widget to another widget, by conducting a search, by changing a diagnosis, etc.). By combining a context of user interaction with displayed user interface content, relevant information and/or functionality can be provided to a user, for example.

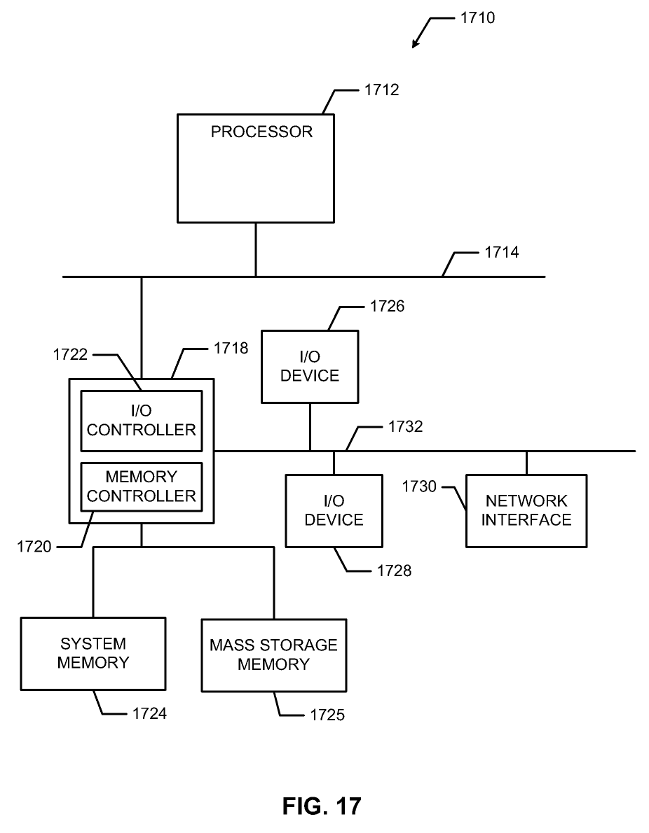

FIG. 17 is a block diagram of an example processor system 1710 that may be used to implement systems and methods described herein. As shown in FIG. 17, the processor system 1710 includes a processor 1712 that is coupled to an interconnection bus 1714. The processor 1712 may be any suitable processor, processing unit, or microprocessor, for example. Although not shown in FIG. 17, the system 1710 may be a multi-processor system and, thus, may include one or more additional processors that are identical or similar to the processor 1712 and that are communicatively coupled to the interconnection bus 1714.

The processor 1712 of FIG. 17 is coupled to a chipset 1718, which includes a memory controller 1720 and an input/output (“I/O”) controller 1722. As is well known, a chipset typically provides I/O and memory management functions as well as a plurality of general purpose and/or special purpose registers, timers, etc. that are accessible or used by one or more processors coupled to the chipset 1718. The memory controller 1720 performs functions that enable the processor 1712 (or processors if there are multiple processors) to access a system memory 1724 and a mass storage memory 1725.

The system memory 1724 may include any desired type of volatile and/or non-volatile memory such as, for example, static random access memory (SRAM), dynamic random access memory (DRAM), flash memory, read-only memory (ROM), etc. The mass storage memory 1725 may include any desired type of mass storage device including hard disk drives, optical drives, tape storage devices, etc.

The J/O controller 1722 performs functions that enable the processor 1712 to communicate with peripheral input/output (“I/O”) devices 1726 and 1728 and a network interface 1730 via an I/O bus 1732. The I/O devices 1726 and 1728 may be any desired type of I/O device such as, for example, a keyboard, a video display or monitor, a mouse, etc. The network interface 1730 may be, for example, an Ethernet device, an asynchronous transfer mode (“ATM”) device, an 802.11 device, a DSL modem, a cable modem, a cellular modem, etc. that enables the processor system 1710 to communicate with another processor system.

While the memory controller 1720 and the I/O controller 1722 are depicted in FIG. 17 as separate blocks within the chipset 1718, the functions performed by these blocks may be integrated within a single semiconductor circuit or may be implemented using two or more separate integrated circuits.

Thus, certain embodiments provide a multi-axis patient health record timeline display. Certain embodiments provide a technical effect of selecting both clinical data elements and clinical encounters to provide information and relationships for patient care. By utilizing a multi-dimensional display, the user has the ability to gain a greater understanding of comprehensive longitudinal data for a patient and to interact with discrete data elements across the continuum of a patient record.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A graphical patient health record timeline interface system, said system comprising:
a spectrum representation graphically representing different types of patient information, the representation navigable by a user to access one or more clinical data elements relating to the patient; and
a plurality of indicators dividing the representation based on encounter,
wherein selecting a clinical data element in the representation provides additional information related to the clinical data element to the user.

2. The system of claim 1, wherein the additional information comprises highlighting clinical data elements in the representation related to the selected clinical data element.

3. The system of claim 1, wherein the additional information comprises a thumbnail preview of a source document corresponding to the selected clinical data element.

4. The system of claim 1, wherein the additional information comprises a full view of a source document corresponding to the selected clinical data element.

5. The system of claim 1, further comprising an encounter-based patient health record timeline axis, encounters and related documents on the encounter-based patient health record timeline axis selectable by the user for review.

6. The system of claim 1, wherein a color and size of a clinical data element indicate a comparison of a value of the particular clinical data element to a normal value for the type of clinical data element.

7. The system of claim 1, wherein a clinical data element includes one or more of lab values, medications, vital signs, episodic care events, problems, immunizations, allergies, and procedures that span individual patient encounters.

8. The system of claim 1, wherein the graphical spectrum representation and the plurality of encounter indicators allow a user to view patient health record data across an entire patient record and focused on an individual clinical data element.

9. The system of claim 1, wherein the spectrum representation and the plurality of indicators are provided as a widget in an adaptive graphical user interface.

10. A method for presenting patient health record information in a timeline for user interaction, said method comprising:
compiling patient health record information in a timeline for graphical representation in a spectrum format including clinical data elements for selection and review by a user via a user interface, the clinical data elements separated by indicators on a separate axis indicating patient encounter boundaries, the representation navigable by a user via the user interface to access one or more clinical data elements relating to the patient; and
displaying additional information regarding a clinical data element in response to user interaction.

11. The method of claim 10, wherein the additional information comprises highlighting clinical data elements in the representation related to the selected clinical data element.

12. The method of claim 10, wherein the additional information comprises a thumbnail preview of a source document corresponding to the selected clinical data element.

13. The method of claim 10, wherein the additional information comprises a full view of a source document corresponding to the selected clinical data element.

14. The method of claim 10, further comprising providing an encounter-based patient health record timeline axis, wherein encounters and related documents on the encounter-based patient health record timeline axis are selectable by the user for review.

15. The method of claim 10, wherein a color and size of a clinical data element indicate a comparison of a value of the particular clinical data element to a normal value for the type of clinical data element.

16. The method of claim 10, wherein a clinical data element includes one or more of lab values, medications, vital signs, episodic care events, problems, immunizations, allergies, and procedures that span individual patient encounters.

17. The method of claim 10, wherein the graphical spectrum representation and the plurality of encounter indicators allow a user to view patient health record data across an entire patient record and focused on an individual clinical data element.

18. The method of claim 10, wherein the spectrum representation and the plurality of indicators are provided as a widget in an adaptive graphical user interface.

19. A machine readable medium having a set of instructions for execution on a computing device, the set of instructions comprising:
a spectrum patient health record representation graphically representing different types of patient information, the representation navigable by a user to access one or more clinical data elements relating to the patient; and
a plurality of indicators dividing the representation based on encounter,
wherein selecting a clinical data element in the representation provides additional information related to the clinical data element to the user.

20. The machine readable medium of claim 19, further comprising an encounter-based patient health record timeline axis, wherein encounters and related documents on the encounter-based patient health record timeline axis are selectable by the user for review.
